(19) United States
(12) Patent Application Publication
(10) Pub. No.: US 2005/0096843 A1
(43) Pub. Date: May 5, 2005

(54) GPS driven, remotely downloaded, electronic tour guide

(76) Inventor: Frank J. Del Monte JR., Phoenix, AZ (US)

Correspondence Address: Frank J. Del Monte, 1429 E. Griswold Road, Phoenix, AZ, 85020, US

(21) Appl. No.: 10/699,034

(22) Filed: Nov. 3, 2003

(51) Int. Cl. G01C 21/30

(52) U.S. Cl. 701/211

(57) ABSTRACT

This invention will provide the user with the same or better level knowledge of a locally based tour guide, no matter where they travel. The user will not have to follow a predetermined tour route, or plan ahead and request local information. All the descriptions of all the types of attractions the user has expressed interested in will be automatically presented to him as he approaches those attractions.

### CROSS-REFERENCE TO RELATED APPLICATIONS

Not Applicable.

### STATEMENT REGARDING FEDERALLY SPONSORED RESEARCH OR DEVELOPMENT

The development of this invention involved no Federal Research or Development. I developed the idea for this device privately with no outside assistance.

### REFERENCE TO SEQUENCE LISTING, A TABLE, OR A COMPUTER PROGRAM LISTING COMPACT DISK

Not Applicable.

### BACKGROUND OF THE INVENTION

I operate a small tour company in Phoenix, Ariz. (www.azluxtours.com) As I continually give the same tours, and my drivers give the same tours, I realized that the tour information could be automated. My first thought was to simply record the tours on audiotape, but that would require synchronizing the tape to the vehicle speed, starting, stopping, meal breaks, and landmarks, or having the drivers manually start and stop the tape as they drive. Then I decided that GPS (Global Positioning System) could be used to trigger the audio system. Once I thought about that, the rest of the concept fell into place.

### BRIEF SUMMARY OF THE INVENTION

The objective of the invention is to allow people to travel anywhere they want and yet have at hand all the information about all the local scenic wonders and tourist related attractions that they would have available if they had a live tour guide riding along with them.

The invention consists of two parts. Part 1, the most important part, is the Remote Unit, which is located in the user's vehicle. For all practical purposes, it is the invention. Part 2, is a standard, central data processing (computer) system, which maintains and downloads the information to the Remote Unit.

As the client (user) drives, the Remote Unit monitors its GPS position. When the unit is in proximity to a tourist or scenic attraction the Remote Unit audibly describes the attractions that fall within parameters preset by the user.

Further details of the inventions operation parameters are included in the “Detailed Description of the Invention” section.

### BRIEF DESCRIPTION OF THE SEVERAL VIEWS OF THE DRAWING

No Drawings are provided.

Drawings of the Central Processing System would serve no purpose, as it is simply a general-purpose computer system.

The Remote Unit is simply going to be an attractive, high impact plastic box, sized as required to contain the components listed in the “Detailed Description of the Invention” section of this document. Early estimates of the size of the remote Unit are approximately 8″×10″×2″.

### DETAILED DESCRIPTION OF THE INVENTION

Part 2, the Central Processing System, is simply a general-purpose computer with large data storage capacity, and access to a telephone modem.

Part 1, the Remote Unit, is the new invention.

The Remote Unit consists of the following components.
1. A microcomputer.
2. An integrated cell phone.
3. A GPS receiver. (Possibly part of the Cell Phone)
4. A user interface data display.
5. A user interface data entry device, probably a keyboard or set of switches.
6. A large amount of solid-state data memory.
7. An audio output device. (Speaker)
8. Headphone jacks for private listening.
9. Software to run the above components.
10. A power cord with a plug, which fits a vehicle cigarette lighter.
11. A back-up battery for memory keep alive and security purposes.

Operational Aspects of the Invention.
1. The Remote Unit will be rented, leased, or sold to the user.
2. When the Remote Unit powers up, it will make a cell phone call to the central computer and “Log In,” telling the central computer it's ID number, It's GPS location, and if it needs a data download.
3. The data download is triggered when the Remote Unit determines it does not have enough data to describe the scenic attractions within a predetermined service area, a circumference of its present position. The circumference of the service area is a data item supplied during the previous data download, or is set to zero upon initial power up, indicating the need for an initial local area download.
4. The user may define the types of attractions to be announced, and the level of detail. Examples could be, National parks, National Monuments, Children's Attractions, Historic Attractions, Natural Wonders, Scenic Views, Ghost Towns, Revolutionary War or Civil War Related, Unusual Place Names, Large Constructions such as Dam or Bridges, or other categories yet to be defined. These preliminary settings will be list driven and the options will be defined by the types of attractions available in the latest download data, or will be set as a standard default upon initial download for this user.
5. As the user travels the Remote Unit monitors its GPS location and compares it to the GPS locations of scenic or tourist attractions and announces the nearby attractions, and the information it has about the attractions via the audio interface (speaker).
6. The remote unit continually monitors its GPS location and when it determines it is approaching an outer limit of the predetermined service area it will use the cell phone to contact the Central Computer System and request a new data download.
7. The Remote Unit will protect itself from loss or theft by monitoring its location, time between GPS location changes, and rental or lease dates. If the Remote Unit determines it has gone outside of a predetermined GPS range, or sat quiescent for too long, or has been retained beyond a predetermined date, it will use its back up battery and cell phone and notify the central System of its location. If it is unable to connect with the Central Computer System it will try alternate numbers. If all connect efforts fail it will set an audible alarm and display a “Call 1-800-xxx-xxxx” message until the batteries fail.

1. I claim that this invention will provide accurate local tourist attraction information to its users as they travel, no matter where they travel, in any area with data maintained by the Central Computer System.
